(19) United States
(12) Patent Application Publication
(10) Pub. No.: US 2026/0135966 A1
(43) Pub. Date: May 14, 2026

(54) SYSTEMS AND METHODS FOR ENTITY-AWARE VIDEO REFRAMING

(71) Applicant: ADOBE INC., SAN JOSE, CA (US)

(72) Inventors: Anh Lan Truong, New York, NY (US); Dingzeyu Li, Sammamish, WA (US); Rebecca Louise Croly, Colchester (GB); Pamela Zoni, London (GB); Lubomira Assenova Dontcheva, Seattle, WA (US); Emelie Olga Johanna Swerre, Hove (GB)

(21) Appl. No.: 18/944,962

(22) Filed: Nov. 12, 2024

(51) Int. Cl. H04N 5/262; G06T 7/11; G06V 10/25; G06V 20/40; H04N 7/01

(52) U.S. Cl. CPC H04N 5/2628; G06T 7/11; G06V 10/25; G06V 20/49; H04N 7/013; G06T 2207/20044

(57) ABSTRACT

A method, apparatus, non-transitory computer readable medium, and system for media processing includes obtaining a video including a first frame depicting an entity and a second frame depicting the entity, where the video has a first aspect ratio, computing a combined bounding box for the entity based on the first frame and the second frame, and generating a modified video based on the combined bounding box, where the modified video has a second aspect ratio different from the first aspect ratio.

### BACKGROUND

The following relates generally to media processing, and more specifically to video processing. A video may be presented according to an aspect ratio (e.g., a ratio of a width of a frame of the video to a height of a frame of the video) that is suitable for display on a particular digital content channel. Video reframing refers to a change in an aspect ratio of a video.

Different digital content channels may display videos according to different aspect ratios from each other, and therefore existing media processing systems attempt to perform video reframing to accommodate different digital content channels. However, existing media processing systems are unable to accurately reframe videos according to one or more entities depicted in the videos. There is therefore a need in the art for systems and methods that perform accurate video reframing.

### SUMMARY

Systems and methods are described for producing a modified video based on an input video having a different aspect ratio than the modified video. In some embodiments, a media processing system determines a combined bounding box for an entity that is depicted across multiple frames of the input video, and reframes the input video based on the combined bounding box to obtain the modified video. Because the modified video is produced based on the combined bounding box for the entity, the media processing system is able to obtain a modified video that more accurately depicts the entity than conventional media processing systems can provide.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a media processing system according to aspects of the present disclosure.

FIG. 2 shows an example of a method for reframing a video according to aspects of the present disclosure.

FIG. 3 shows an example of modified videos according to aspects of the present disclosure.

FIG. 4 shows an example of a media processing system for producing a modified video according to aspects of the present disclosure.

FIG. 5 shows a comparative example of a modified video according to aspects of the present disclosure.

FIG. 6 shows an example of a modified video according to aspects of the present disclosure.

FIG. 7 shows an example of a modified picture-in-picture video according to aspects of the present disclosure.

FIG. 8 shows an example of a method for producing a modified video according to aspects of the present disclosure.

FIG. 9 shows an example of a method for computing a combined bounding box according to aspects of the present disclosure.

FIG. 10 shows an example of an algorithm for producing a modified video according to aspects of the present disclosure.

FIG. 11 shows an example of a computing device according to aspects of the present disclosure.

FIG. 12 shows an example of a media processing apparatus according to aspects of the present disclosure.

### DETAILED DESCRIPTION

### Overview

The following relates generally to media processing, and more specifically to video processing. A video may be presented according to an aspect ratio (e.g., a ratio of a width of a frame of the video to a height of a frame of the video) that is suitable for display on a particular digital content channel. Video reframing refers to a change in an aspect ratio of a video.

Different digital content channels may display videos according to different aspect ratios from each other, and therefore existing media processing systems attempt to perform video reframing to accommodate different digital content channels. However, existing media processing systems are unable to accurately reframe videos according to one or more entities depicted in the videos.

For example, some conventional media processing systems use saliency detection to perform video reframing. Saliency detection is a process of using saliency maps to determine a most salient object depicted in each frame of a video. A video may be reframed according to the saliency maps. However, saliency detection models generate saliency maps independently of entities depicted in a video, and may therefore generate a saliency map that focuses on an object rather than an entity depicted in a video. A video reframed according to such a saliency map may therefore be inaccurate because it may not show the most relevant entity at any given point of the video.

Accordingly, systems and methods are described for producing a modified video based on an input video having a different aspect ratio than the modified video. In some embodiments, a media processing system determines a combined bounding box for an entity that is depicted across multiple frames of the input video, and reframes the input video based on the combined bounding box to obtain the modified video. Because the modified video is produced based on the combined bounding box for the entity, the media processing system is able to obtain a modified video that more accurately depicts the entity than conventional media processing systems can provide.

Furthermore, in some embodiments, the media processing system determines multiple combined bounding boxes for multiple entities depicted in a video, and produces a modified video using multiple spatial blocks that correspond to the multiple combined bounding boxes. Because the modified video is produced using the multiple spatial blocks, content from the video corresponding to the multiple entities is effectively isolated, and the media processing system therefore is able to avoid a visually distracting depiction of overlapping content.

### Terminology Examples

A “video” is a set of one or more frames that may be displayed consecutively to “play” the video. A “frame” is an image. A video may also include audio data. An “aspect ratio” is a ratio of a width of a frame of a video to a height of the frame. An “entity” refers to a being. Examples of an entity include a person and an animal. In some embodiments, an entity does not include an inanimate object. A “bounding box” refers to a rectangle that surrounds at least a portion of an entity or an object within a frame

An example of the media processing system is used in a social media context. In an example, a user has a video that depicts two speakers, and wants to upload the video to a social media channel that displays videos in a vertical aspect ratio. The video has a horizontal aspect ratio. The user provides the video to the media processing system. The media processing system determines combined bounding boxes across frames of the video for each of the two speakers and reframes the video according to the combined bounding boxes. The media processing system also reframes the video according to two spatial blocks for the two speakers so that separate content from the video for the two speakers does not overlap in the reframed video. The media processing system may upload the reframed video to the social media channel, or may provide the reframed video to the user.

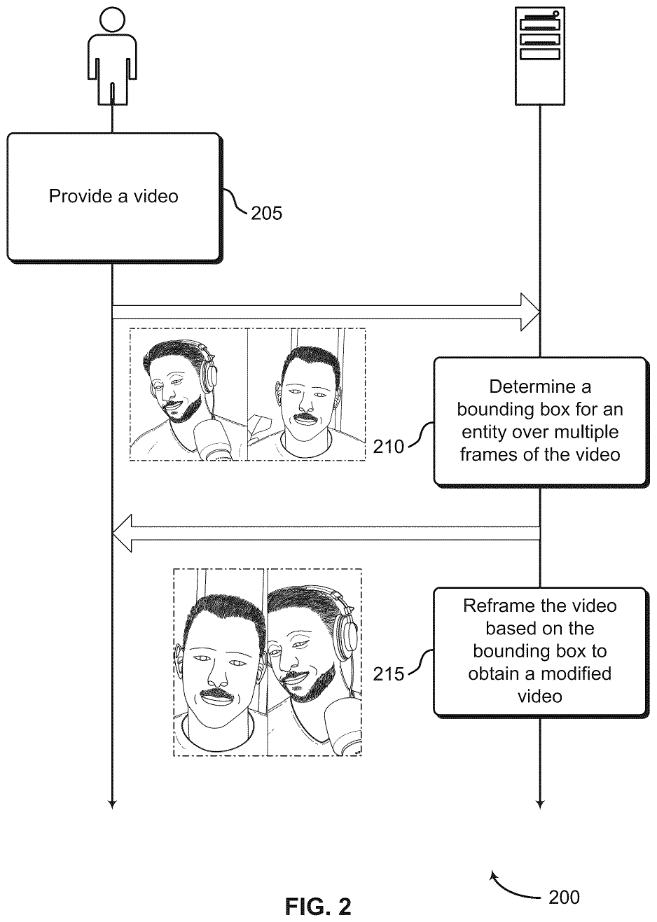

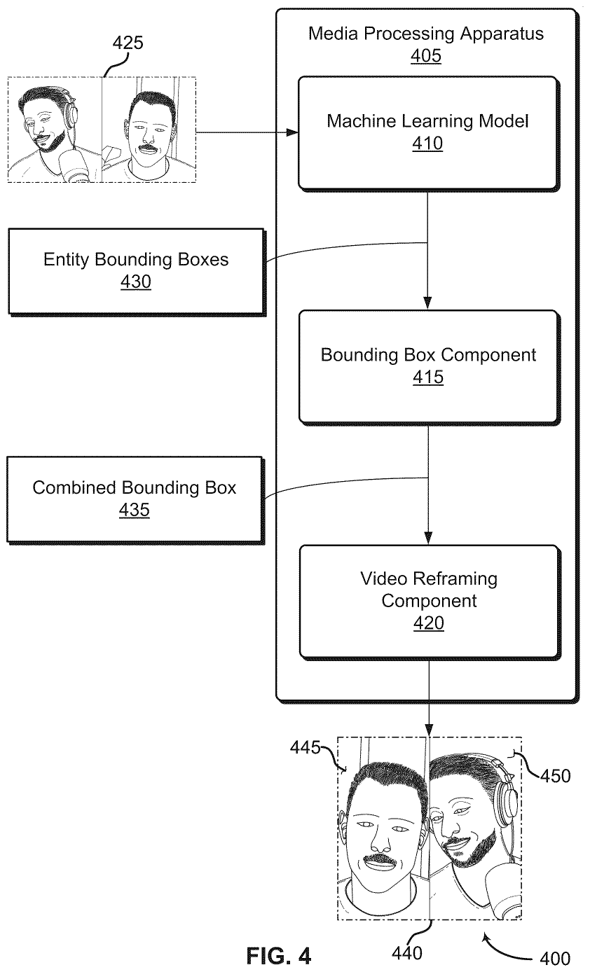

Further example applications of the present disclosure in a video reframing context are provided with reference to FIGS. 2-7. Details regarding the architecture of the media processing system are provided with reference to FIGS. 4 and 11-12. Examples of a process for producing a modified video are provided with reference to FIGS. 2 and 8-10.

### Media Processing System

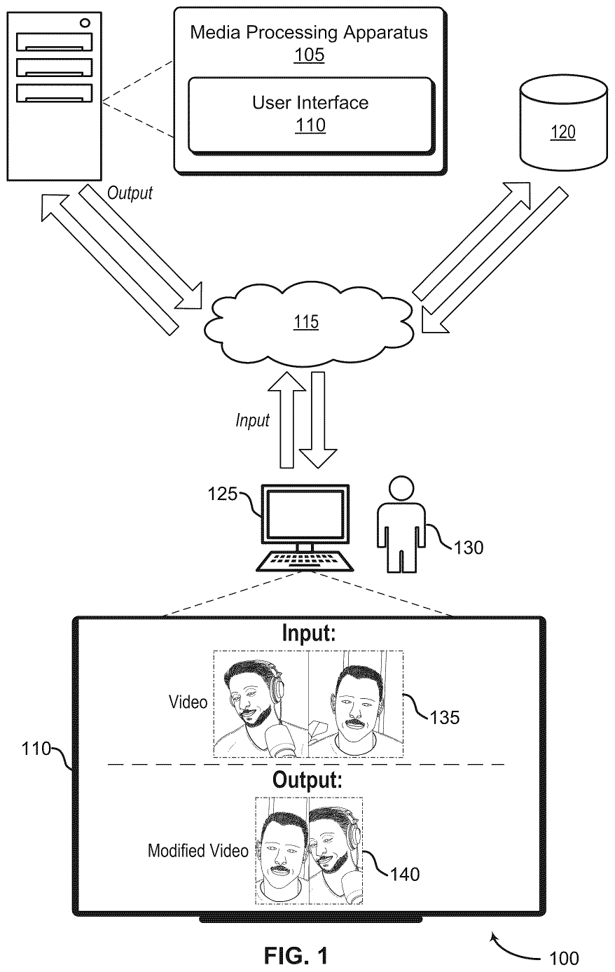

FIG. 1 shows an example of a media processing system 100 according to aspects of the present disclosure. The example shown includes media processing system 100, user device 125, user 130, video 135, and modified video 140. In one aspect, media processing system 100 includes media processing apparatus 105, cloud 115, and database 120. In one aspect, media processing apparatus 105 includes user interface 110. Media processing system 100 is an example of, or includes aspects of, the corresponding element described with reference to FIG. 4.

Referring to FIG. 1, according to some aspects, a user (e.g., user 130) provides a video (e.g., video 135) to media processing apparatus 105 via user interface 110 displayed on a user device (e.g., user device 125) by media processing apparatus 105. The video has a first aspect ratio and depicts one or more entities in one or more frames. For example, video 135 has a horizontal (e.g., 16:9) aspect ratio and depicts two people (e.g., a first entity and a second entity).

Media processing apparatus 105 determines a bounding box for each of the one or more entities in one or more of the frames of the video, and computes a combined bounding box for each of the entities by combining an area of two or more bounding boxes for each of the entities. Media processing apparatus 105 then produces a modified video (e.g., modified video 140) by reframing the video according to the combined bounding box and a target aspect ratio. For example, modified video 140 has a square (1:1) aspect ratio, and depicts an area of video 135 that is resized to fit the square aspect ratio.

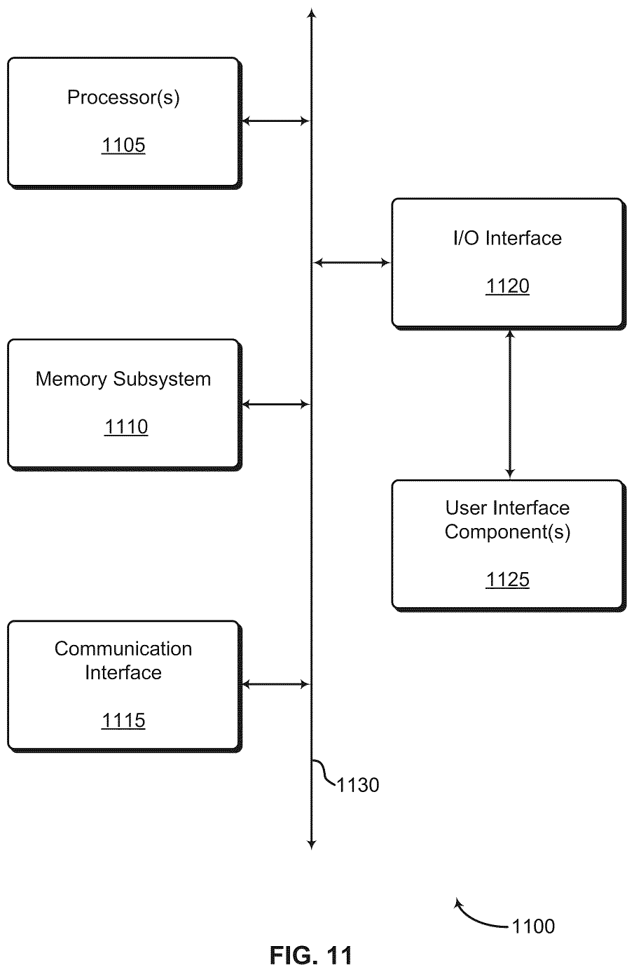

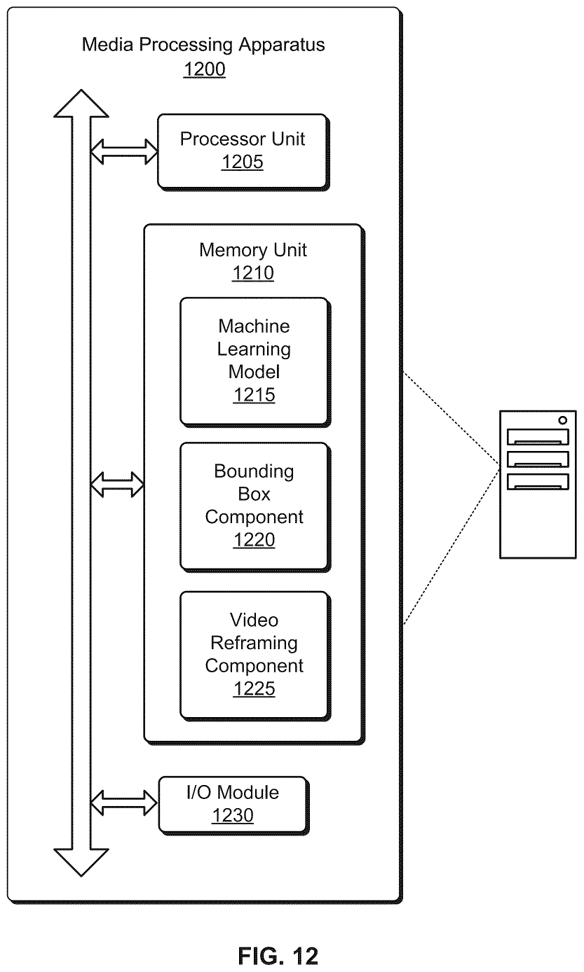

Media processing apparatus 105 is an example of, or includes aspects of, the corresponding element described with reference to FIGS. 4, 11, and 12. According to some aspects, media processing apparatus 105 includes a computer-implemented network. In some embodiments, the computer-implemented network includes a machine learning model (such as the machine learning model 1215 described with reference to FIG. 12). Media processing apparatus 105 may also include one or more processors, a memory subsystem, a communication interface, an I/O interface, one or more user interface components, and a bus as described with reference to FIG. 11. Additionally, media processing apparatus 105 may communicate with user device 125 and database 120 via cloud 115. According to some aspects, user interface 110 comprises a text interface, a graphical user interface, or a combination thereof.

According to some aspects, media processing apparatus 105 is implemented on a server. A server provides one or more functions to users linked by way of one or more of various networks, such as cloud 115. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

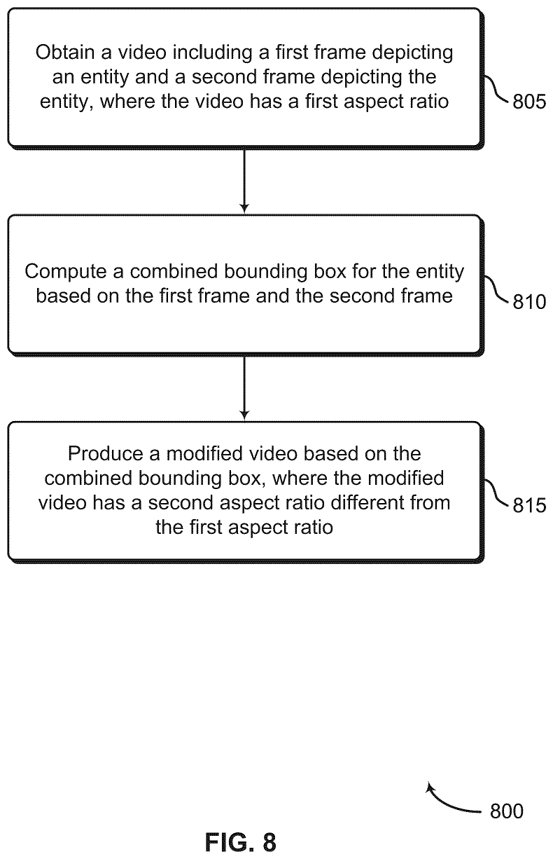

Further detail regarding the architecture of a media processing system is provided with reference to FIGS. 4 and 11-12. Further detail regarding a process for producing a modified video is provided with reference to FIGS. 8-10.

Cloud 115 is a computer network configured to provide on-demand availability of computer system resources, such as data storage and computing power. Cloud 115 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 115 may be limited to a single organization or be available to many organizations. In one example, cloud 115 includes a multi-layer communications network comprising multiple edge routers and core routers. In another example, cloud 115 is based on a local collection of switches in a single physical location. According to some aspects, cloud 115 provides communications between media processing apparatus 105, database 120, and user device 125.

Database 120 is an organized collection of data. In an example, database 120 stores data in a specified format known as a schema. According to some aspects, database 120 is structured as a single database, a distributed database, multiple distributed databases, or an emergency backup database. A database controller may manage data storage and processing in database 120. A user may interact with the database controller, or the database controller may operate automatically without interaction from the user. According to some aspects, database 120 is included in media processing apparatus 105. According to some aspects, database 120 is external to media processing apparatus 105 and communicates with media processing apparatus 105 via cloud 115.

According to some aspects, user device 125 is a personal computer, laptop computer, mainframe computer, palmtop computer, personal assistant, mobile device, or any other suitable processing apparatus. User device 125 may include software that displays user interface 110 provided by media processing apparatus 105. The user interface 110 allows information to be communicated between user 130 and media processing apparatus 105.

According to some aspects, a user device user interface enables a user to interact with user device 125. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

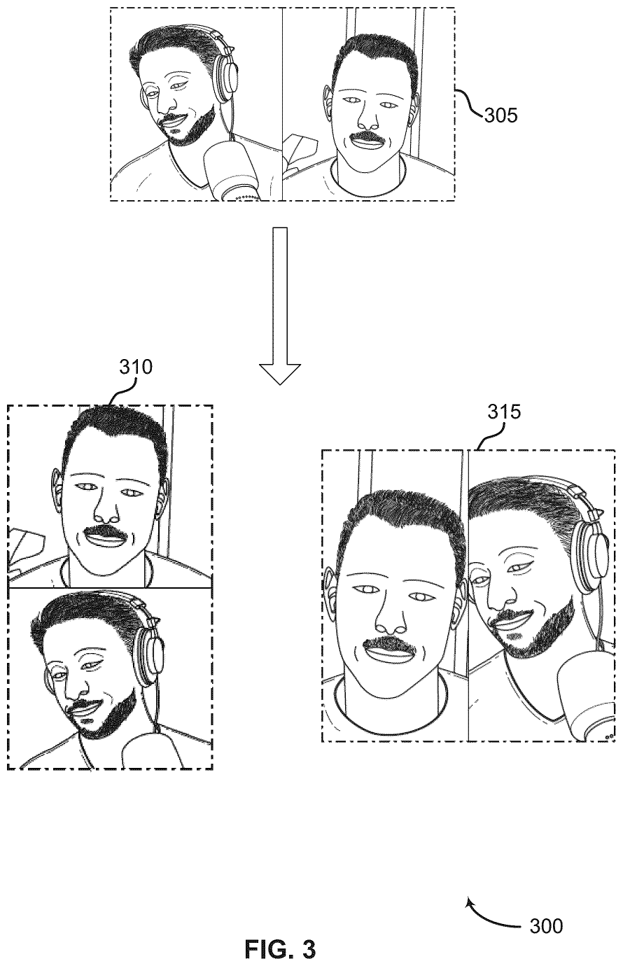

Video 135 is an example of, or includes aspects of, the corresponding element described with reference to FIGS. 3, 4, 6, and 7. Modified video 140 is an example of, or includes aspects of, the corresponding element described with reference to FIGS. 3-7.

FIG. 2 shows an example of a method 200 for reframing a video according to aspects of the present disclosure. Referring to FIG. 2, according to some aspects, a media processing system (such as the media processing system 100 described with reference to FIG. 1) performs method 200 to produce a modified video based on an input video, where the input video has a first aspect ratio and the modified video has a second aspect ratio.

At operation 205, a user provides a video. In an example, a user (such as the user 130 described with reference to FIG. 1) provides the video to a user interface (such as the user interface 110 described with reference to FIG. 1) displayed on a user device (such as the user device 125 described with reference to FIG. 1) by the media processing apparatus.

At operation 210, the system determines a bounding box for an entity over multiple frames of the video. In some cases, the operations of this step refer to, or may be performed by, a media processing apparatus as described with reference to FIGS. 1, 4, 11, and 12. In an example, the media processing apparatus computes a combined bounding box as described with reference to FIGS. 4 and 8-10.

At operation 215, the system reframes the video based on the bounding box to obtain a modified video. In some cases, the operations of this step refer to, or may be performed by, a media processing apparatus as described with reference to FIGS. 1, 4, 11, and 12. In an example, the media processing apparatus produces the modified video as described with reference to FIGS. 4 and 8-10.

FIG. 3 shows an example of modified videos 310 according to aspects of the present disclosure. The example shown includes video 305, first modified video 310, and second modified video 315. Referring to FIG. 3, video 305 depicts two people (e.g., a first and a second entity) and has a horizontal (e.g., 16:9) aspect ratio, or a rectangular aspect ratio in which a width of the video is greater than a height of the video.

A media processing system, such as the media processing system 100 described with reference to FIG. 1, may produce a modified video based on video 305 having a different aspect ratio than video 305. In an example, the media processing system produces first modified video 310 having a vertical (e.g., 9:16) aspect ratio for a display format having the vertical aspect ratio. In another example, the media processing system produces second modified video 315 having a square (1:1) aspect ratio for a display format having the square aspect ratio.

Video 305 is an example of, or includes aspects of, the corresponding element described with reference to FIGS. 1, 4, 6, and 7. First modified video 310 and second modified video 315 are examples of, or include aspects of, the corresponding elements described with reference to FIGS. 1 and 4-7.

FIG. 4 shows an example of a media processing system 400 for producing a modified video according to aspects of the present disclosure. The example shown includes media processing system 400, video 425, entity bounding boxes 430, combined bounding box 435, and modified video 440. In one aspect, media processing system 400 includes media processing apparatus 405. In one aspect, media processing apparatus 405 includes machine learning model 410, bounding box component 415, and video reframing component 420. In one aspect, modified video 440 includes first spatial block 445 and second spatial block 450.

Referring to FIG. 4, media processing system 400 obtains a modified video by reframing a video having any aspect ratio. In some embodiments, the modified video has a horizontal (e.g., 16:9) aspect ratio, a square (e.g., 1:1) aspect ratio, or a vertical (e.g., 9:16) aspect ratio.

According to some aspects, media processing apparatus 405 obtains a video (e.g., video 425) including a first frame depicting an entity and a second frame depicting the entity. The video has a first aspect ratio.

In some embodiments, machine learning model 410 detects one or more entities depicted in one or more frames of the video and determines a skeleton for each detected entity. A “skeleton” is a set of connected coordinates that represent a position of an entity within a frame. Machine learning model 410 may compute one or more bounding boxes (e.g., entity bounding boxes 430) for each skeleton. In some embodiments, machine learning model 410 computes the bounding box by identifying a corner coordinate (e.g., a top-left coordinate), a width, and a height of a box defined by one or more coordinates of the skeleton corresponding to ears of the entity, one or more coordinates of the skeleton corresponding to eyes of the entity, and one or more coordinates of the skeleton corresponding to a nose of the entity.

In some embodiments, bounding box component 415 discards any bounding box for a skeleton that does not include vertices corresponding to two eyes of an entity. In some embodiments, bounding box component 415 discards any bounding box having a side that is less than a predetermined fraction of a corresponding side of the video. For example, bounding box component 415 may discard a bounding box having a width that is less than one tenth of a width of the video.

In some embodiments, bounding box component 415 identifies bounding boxes that belong to a same entity in a contiguous time interval. In an example, bounding box component 415 associates two bounding boxes appearing within two frames that are displayed within a predetermined time (e.g., 0.5 seconds) from each other and having areas that overlap with each other by a predetermined amount (e.g., 50%) as belonging to a same entity. Bounding box component 415 may compute the overlap as an intersection of the two bounding boxes over a union of the two bounding boxes.

In some embodiments, bounding box component 415 associates an entity ID with each group of bounding boxes determined to belong to a same entity. In some embodiments, bounding box component 415 discards any entity ID corresponding to an entity that is depicted in the video for less than a predetermined amount of time (e.g., two seconds), thereby helping to avoid missed detections or emphasizing irrelevant entities.

In some embodiments, bounding box component 415 produces an intermediate video by segmenting the video into one or more temporal shots, where a temporal shot includes one or more frames of the video, and joining the one or more temporal shots. In an example, bounding box component 415 identifies each consecutive frame of the video corresponding to a same group of entity IDs (or corresponding to no entity IDs), and identifies the consecutive frame(s) as a temporal shot. In other words, for example, a portion of the video including 20 frames showing two same entities may be identified as a temporal shot. Bounding box component 415 then joins each temporal shot in consecutive temporal order to obtain the intermediate video.

In some embodiments, bounding box component 415 receives a timestamped transcript of the video that identifies changes of speakers in the video. In some embodiments, bounding box component 415 identifies each consecutive frame of the video corresponding to a single speaker based on the transcript as a temporal shot, where a change in speaker corresponds to a different temporal shot.

In some embodiments, bounding box component 415 merges any temporal shot having a duration that is less than a predefined duration (e.g., two seconds) into an adjacent shot of the intermediate video. In an example, where a short temporal shot is adjacent to a temporal shot that does not depict any entities, bounding box component 415 extends a duration of the temporal shot that does not depict any entities to an amount equal to the duration of the short temporal shot, adds audio data from the short temporal shot to the adjacent temporal shot, and discards the short temporal shot from the intermediate video. In an example, where a short temporal shot is adjacent to two shots that do not depict any entities, or is adjacent to two shots that depict one or more entities, bounding box component 415 extends a duration of a shortest adjacent shot to an amount equal to the duration of the short temporal shot, adds audio data from the short temporal shot to the shortest adjacent shot, and discards the short temporal shot from the intermediate video.

In some embodiments, bounding box component 415 computes a combined bounding box (e.g., combined bounding box 435) by combining two or more bounding boxes from two or more frames of a temporal shot that correspond to a same entity ID. In an example, a first frame of a temporal shot includes a first bounding box corresponding to an entity ID and a second frame of the temporal shot includes a second bounding box corresponding to the same entity ID. Bounding box component 415 combines an area of the first bounding box and the second bounding box to obtain the combined bounding box. In some embodiments, bounding box component 415 applies the combined bounding box to each frame of a temporal shot corresponding to the combined bounding box.

In some embodiments, bounding box component 415 determines that one combined bounding box corresponding to one entity ID overlaps another combined bounding box corresponding to another entity ID and merges the overlapping combined bounding boxes to obtain a merged combined bounding box based on the determination.

In some embodiments, bounding box component 415 may determine that a temporal shot of the intermediate video depicts a picture-in-picture video. For example, bounding box component 415 determines that a corner of the combined bounding box overlaps with a corner of the intermediate video. In response to the determination, bounding box component 415 may identify that a ratio of a length of a side of the combined bounding box to a length of a side of the intermediate video is less than or equal to a predetermined ratio (e.g., 1:4), and therefore determine that the temporal shot depicts a picture-in-picture video.

In some embodiments, video reframing component 420 produces a modified video (e.g., modified video 440) based on the combined bounding box. In an example, video reframing component 420 obtains the intermediate video, a target aspect ratio, and the combined bounding box. Video reframing component 420 expands an area of the combined bounding box to obtain a medium crop of the intermediate video, determines a center point of the medium crop (e.g., a point that is equidistant from each corner of the medium crop), and centers the medium crop based on the center point in a spatial block having an area corresponding to the target aspect ratio. Video reframing component 420 resizes the medium crop to fit within the spatial block and expands an area of the intermediate video around the medium crop to fill the spatial block, thereby obtaining the modified video.

In some embodiments, where the intermediate video depicts two entities and bounding box component 415 computes two combined bounding boxes corresponding to the two entities, video reframing component 420 divides a spatial block having an area corresponding to the target aspect ratio into two spatial blocks corresponding to the two combined bounding boxes, respectively, and arranges the spatial blocks according to the target aspect ratio. In an example, where the target aspect ratio is vertical, video reframing component 420 places the two spatial blocks vertically adjacent to each other, and where the target aspect ratio is square or horizontal, video reframing component 420 places the two spatial blocks horizontally adjacent to each other. Video reframing component 420 expands an area of each combined bounding box to obtain mediums crop of the intermediate video, determines center points of the medium crops, and centers the medium crops based on the center points in the corresponding spatial blocks. Video reframing component 420 resizes the medium crops to fit within the spatial blocks and expands areas of the intermediate video around the medium crops to fill the spatial blocks, thereby obtaining the modified video.

In the example of FIG. 4, video 425 depicts two entities. Video reframing component determines first spatial block 445 and second spatial block 450 based on combined bounding boxes for the two entities and resizes corresponding crops of an intermediate video to fit within first spatial block 445 and second spatial block 450, respectively, to obtain modified video 440.

In some embodiments, where the intermediate video depicts three entities and bounding box component 415 computes three combined bounding boxes corresponding to the three entities, video reframing component 420 divides a spatial block having an area corresponding to the target aspect ratio into three spatial blocks corresponding to the three combined bounding boxes, respectively, and arranges the spatial blocks according to the target aspect ratio. In an example, where the target aspect ratio is vertical, video reframing component 420 places the three spatial blocks vertically adjacent to each other, and where the target aspect ratio is square or horizontal, video reframing component 420 places the three spatial blocks horizontally adjacent to each other. Video reframing component 420 expands an area of each combined bounding box to obtain mediums crop of the intermediate video, determines center points of the medium crops, and centers the medium crops based on the center points in the corresponding spatial blocks. Video reframing component 420 resizes the medium crops to fit within the spatial blocks and expands areas of the intermediate video around the medium crops to fill the spatial blocks, thereby obtaining the modified video.

In some embodiments, where the intermediate video depicts four entities and bounding box component 415 computes four combined bounding boxes corresponding to the four entities, video reframing component 420 divides a spatial block having an area corresponding to the target aspect ratio into four spatial blocks corresponding to the four combined bounding boxes, respectively, and arranges the four spatial blocks in a two-by-two grid. Video reframing component 420 expands an area of each combined bounding box to obtain mediums crop of the intermediate video, determines center points of the medium crops, and centers the medium crops based on the center points in the corresponding spatial blocks. Video reframing component 420 resizes the medium crops to fit within the spatial blocks and expands areas of the intermediate video around the medium crops to fill the spatial blocks, thereby obtaining the modified video.

In some embodiments, where the video has a horizontal or square aspect ratio and where a temporal shot of the intermediate video depicts no entities, or depicts more than four entities corresponding to more than four combined bounding boxes, video reframing component 420 centers the intermediate video and resizes the intermediate video such that the intermediate video spans a full width of a spatial block having an area corresponding to the target aspect ratio. Video reframing component 420 may fill in a gap in the spatial block with a blurred version of the intermediate video.

In some embodiments, where the video has a vertical aspect ratio and where a temporal shot of the intermediate video depicts no entities, or depicts more than four entities corresponding to more than four combined bounding boxes, video reframing component 420 centers the intermediate video and resizes the intermediate video such that the intermediate video spans a full height of a spatial block corresponding to the target aspect ratio. Video reframing component 420 may fill in a gap in the spatial block with a blurred version of the intermediate video.

In some embodiments, where video reframing component 420 receives a merged combined bounding box for a temporal shot corresponding to two or more entities, video reframing component resizes the intermediate video based on the merged combined bounding box and a spatial block having an area corresponding to the target aspect ratio and fills a gap in the spatial block with a blurred version of the intermediate video.

In some embodiments, where video reframing component 420 receives a merged combined bounding box for a temporal shot corresponding to two or more entities, video reframing component resizes the temporal shot based on the merged combined bounding box and an aspect ratio corresponding to a spatial block having an area corresponding to the target aspect ratio and fills a gap in the spatial block with a blurred version of the temporal shot.

In some embodiments, in response to a determination that a temporal shot depicts a picture-in-picture video, video reframing component 420 resizes the temporal shot based on the merged combined bounding box and a spatial block having an area corresponding to the target aspect ratio, such that an entire area of the temporal shot is included in the spatial block, and fills a gap in the spatial block with a blurred version of the temporal shot. Video reframing component 420 may exclude other spatial blocks from being displayed while the temporal shot is displayed.

In some embodiments, where video reframing component 420 receives a temporal shot identified based on a transcript indicating a speaker, video reframing component 420 expands an area of a combined bounding box corresponding to the speaker to obtain a medium crop of the intermediate video and centers a center point of the medium crop in a spatial block having an area corresponding to the target aspect ratio. Video reframing component 420 resizes the medium crop to fit within the spatial block and expands an area of the intermediate video around the medium crop to fill the spatial block. Video reframing component 420 may exclude other spatial blocks corresponding to non-speakers from being displayed while the temporal shot is displayed.

Media processing system 400 is an example of, or includes aspects of, the corresponding element described with reference to FIG. 1. Media processing apparatus 405 is an example of, or includes aspects of, the corresponding element described with reference to FIGS. 1, 11, and 12. Machine learning model 410, bounding box component 415, and video reframing component 420 are examples of, or include aspects of, the corresponding elements described with reference to FIG. 12.

According to some aspects, machine learning model 410 comprises machine learning parameters stored in a memory unit of media processing apparatus 405 (such as the memory unit 1210 described with reference to FIG. 12). According to some aspects, machine learning model 410 comprises an artificial neural network (ANN) configured to detect an entity depicted in a video input, determine a skeleton for the detected entity, and determine a bounding box for the entity based on the skeleton. In some cases, the ANN comprises a pose estimation model comprising a transformer, a vision transformer (ViT), a convolutional neural network (CNN), a Mask R-CNN, or the like.

A ViT is an architecture designed for image processing that draws inspiration from transformer models originally developed for natural language processing. Instead of relying on convolutions, a ViT treats an image as a sequence of patches.

In this approach, the image is divided into smaller, fixed-size patches, such as 16×16 pixels. Each of these patches is then flattened into a one-dimensional vector. These vectors are transformed into embeddings through a linear projection, creating a representation that captures the essential features of each patch. To maintain the spatial relationships between patches, positional encodings are added, similar to how positional information is incorporated in NLP.

Once the patches are embedded and enriched with positional information, they are passed through multiple layers of the ViT architecture. These layers include self-attention mechanisms that allow the model to determine the relevance of each patch in relation to others, enabling it to capture long-range dependencies and intricate relationships within the image. After processing through these layers, a special classification token is utilized to generate the final output.

A CNN is an ANN that is designed for processing structured grid data, such as images. The fundamental building block of a CNN is the convolutional layer, which applies a set of learnable filters to the input image. As these filters slide over the image, they detect various features, such as edges, textures, and shapes. This process allows the network to learn spatial hierarchies, capturing increasingly complex patterns as the data moves through multiple layers.

In addition to convolutional layers, CNNs typically incorporate pooling layers, which downsample the feature maps generated by the convolutional layers. This downsampling helps to reduce the dimensionality of the data while preserving important features, making the network more efficient and less prone to overfitting. Common pooling methods include max pooling and average pooling, both of which help retain the most significant information from the feature maps.

As the data progresses through the CNN, it usually passes through several convolutional and pooling layers, gradually abstracting the features until reaching the fully connected layers. These final layers interpret the high-level features extracted by the earlier layers and are often used for classification tasks. The output layer produces the final predictions.

Mask R-CNN is an extension of a Faster R-CNN architecture and is designed for instance segmentation tasks in computer vision. The Mask R-CNN identifies objects within an image and also generates a pixel-wise mask for each detected instance.

The Mask R-CNN passes an image through a backbone network, typically a CNN, which extracts feature maps that provide a rich representation of contents the image. Then a region proposal network (RPN) generates potential bounding boxes where objects might be located. The RPN outputs a set of proposals that are refined based on a likelihood of containing objects. After the proposals are generated, the Mask R-CNN performs a region of interest align operation to ensure that features corresponding to each proposed region are accurately aligned with the original input image, mitigating quantization issues.

Each of the proposed regions is then fed into two branches, one for classification bounding box regression, and another for generating segmentation masks. The segmentation branch produces binary masks for each instance, indicating the exact pixels that belong to the detected objects. As a result, the Mask R-CNN can effectively distinguish between overlapping objects, providing detailed spatial information.

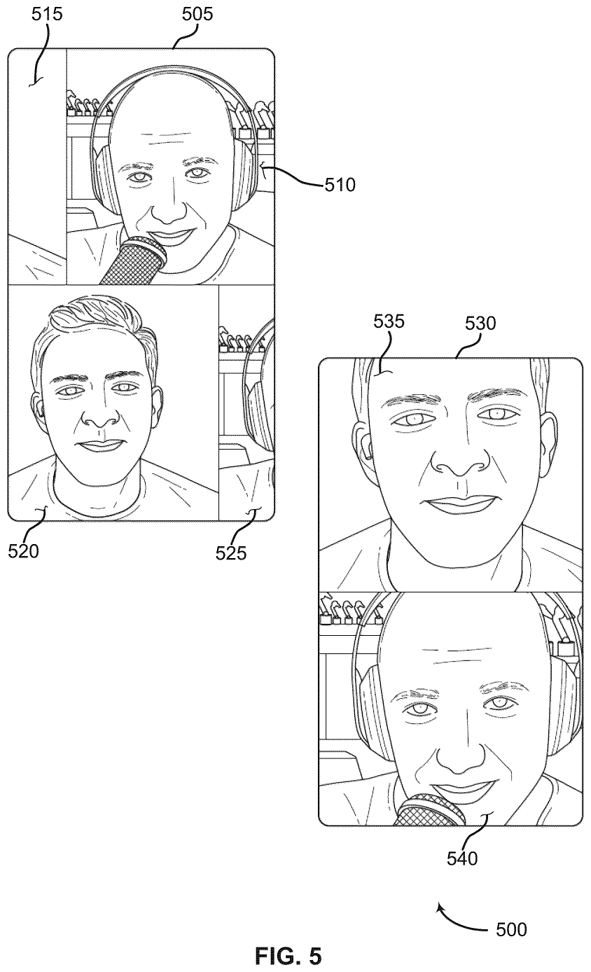

Video 425 is an example of, or includes aspects of, the corresponding element described with reference to FIGS. 1, 3, 6, and 7. Modified video 440 is an example of, or includes aspects of, the corresponding element described with reference to FIGS. 1, 3, and 5-7. First spatial block 445 and second spatial block 450 are examples of, or include aspects of, the corresponding elements described with reference to FIG. 5.

FIG. 5 shows a comparative example 500 of a modified video according to aspects of the present disclosure. The example shown includes comparative modified video 505 and modified video 530. Referring to FIG. 5, comparative modified video 505 is an example of a comparative modified video produced by a comparative video processing system based on an input video depicting two people in two different frames. Comparative modified video 505 includes first portion 510 depicting a first person and second portion 520 depicting a second person. However, comparative modified video 505 also includes first overlap area 515 next to first portion 510 and second overlap area 525 next to second portion 520. First overlap area 515 is an unwanted region of first portion 510, and second overlap area 525 is an unwanted region of first portion 510.

By contrast, modified video 530 is an example of a modified video produced based on the same input video using the process described with reference to FIG. 4. Modified video 530 includes first spatial block 535 and second spatial block 540. Because modified video 530 is produced based on first spatial block 535 and second spatial block 540, modified video 530 avoids depicting any overlap areas as shown in comparative modified video 505.

Modified video 530 is an example of, or includes aspects of, the corresponding element described with reference to FIGS. 1, 3, 4, 6, and 7. First spatial block 535 and second spatial block 540 are examples of, or include aspects of, the corresponding elements described with reference to FIG. 4.

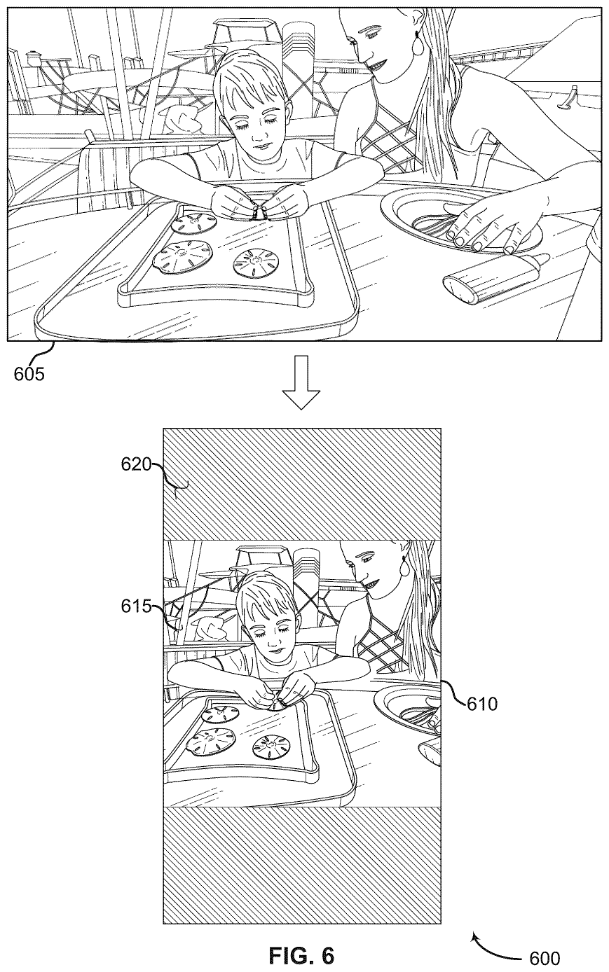

FIG. 6 shows an example 600 of a modified video according to aspects of the present disclosure. The example shown includes video 605 and modified video 610. In one aspect, modified video 610 includes spatial block 615 and filled gap area 620.

Referring to FIG. 6, video 605 depicts two people in a same frame with each other. Using the process described with reference to FIG. 4, a media processing apparatus detects overlapping bounding boxes for each of the people. Because the bounding boxes overlap, the media processing apparatus produces modified video 610 by computing a merged combined bounding box and reframing video 605 based on spatial block 615 and the merged combined bounding box. The media processing apparatus produces filled gap area 620 by blurring video 605. Accordingly, because modified video 610 is produced based on the merged combined bounding box, the media processing apparatus avoids producing a modified video that would include two different spatial blocks for the two closely spaced people and that would therefore show overlapping content.

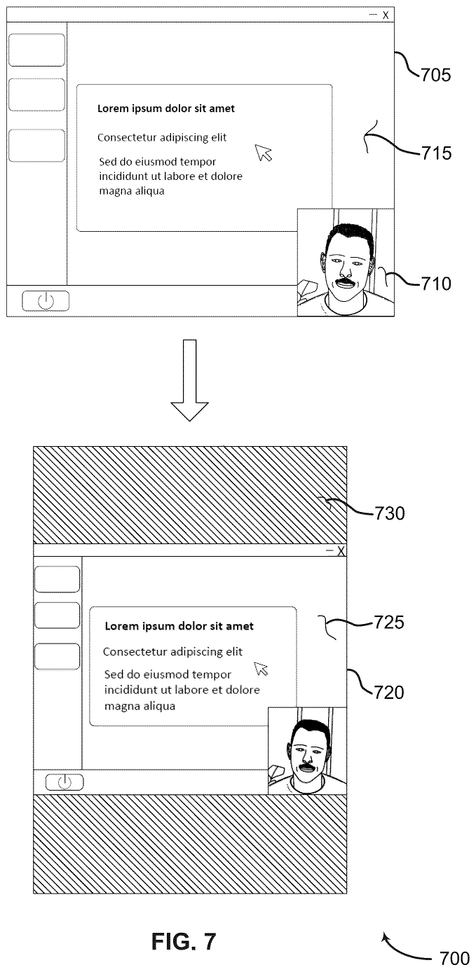

Video 605 is an example of, or includes aspects of, the corresponding element described with reference to FIGS. 1, 3, 4, and 7. Modified video 610 is an example of, or includes aspects of, the corresponding element described with reference to FIGS. 1, 3-5, and 7. Spatial block 615 is an example of, or includes aspects of, the corresponding element described with reference to FIG. 7. Filled gap area 620 is an example of, or includes aspects of, the corresponding element described with reference to FIG. 7.

FIG. 7 shows an example 700 of a modified picture-in-picture video according to aspects of the present disclosure. The example shown includes video 705 and modified video 720. In one aspect, video 705 includes inset frame 710 and large frame 715. In one aspect, modified video 720 includes spatial block 725 and filled gap area 730.

Referring to FIG. 7, using the process described with reference to FIG. 4, a media processing apparatus determines that a corner of a bounding box of the person depicted in inset frame 710 is disposed in a corner of video 705, and that a height of the bounding box is less than ¼ of a height of video 705, and that video 705 therefore comprises a picture-in-picture video in which inset frame 710 is displayed in large frame 715.

Accordingly, rather than expanding a region of video 705 included the bounding box to fit spatial block 725, the media processing apparatus fits the entire video 705 to spatial block 725 and produces filled gap area 730 to produce modified video 720. The media processing apparatus therefor is able to avoid excluding relevant picture-in-picture content from modified video 720.

Video 705 is an example of, or includes aspects of, the corresponding element described with reference to FIGS. 1, 3, 4, and 6. Modified video 720 is an example of, or includes aspects of, the corresponding element described with reference to FIGS. 1, and 3-6. Spatial block 725 is an example of, or includes aspects of, the corresponding element described with reference to FIG. 6. Filled gap area 730 is an example of, or includes aspects of, the corresponding element described with reference to FIG. 6.

### Video Reframing

FIG. 8 shows an example of a method 800 for producing a modified video according to aspects of the present disclosure. Referring to FIG. 8, according to some aspects, a media processing apparatus (such as the media processing apparatus 1200 described with reference to FIG. 12) performs method 800 to produce a modified video based on an input video, where the input video has a first aspect ratio and the modified video has a second aspect ratio.

At operation 805, the system obtains a video including a first frame depicting an entity and a second frame depicting the entity, where the video has a first aspect ratio. In some cases, the operations of this step refer to, or may be performed by, a media processing apparatus as described with reference to FIGS. 1, 4, 11, and 12. In an example, a user (such as the user 130 described with reference to FIG. 1) provides the video to a user interface (such as the user interface 110 described with reference to FIG. 1) displayed on a user device (such as the user device 125 described with reference to FIG. 1) by the media processing apparatus.

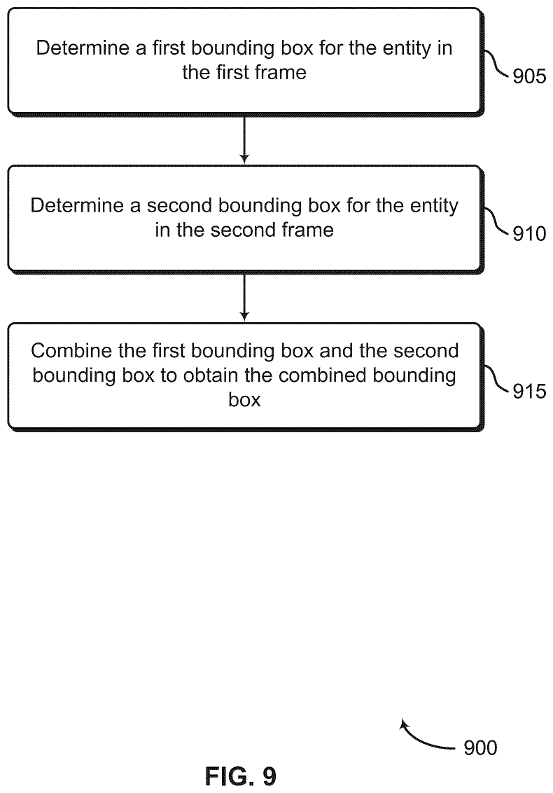

At operation 810, the system computes a combined bounding box for the entity based on the first frame and the second frame. In some cases, the operations of this step refer to, or may be performed by, a bounding box component as described with reference to FIGS. 4 and 12. In an example, the bounding box component computes the combined bounding box as described with reference to FIG. 9.

At operation 815, the system produces a modified video based on the combined bounding box, where the modified video has a second aspect ratio different from the first aspect ratio. In some cases, the operations of this step refer to, or may be performed by, a video reframing component as described with reference to FIGS. 4 and 12. In an example, the video reframing component produces the modified video as described with reference to FIG. 4.

FIG. 9 shows an example of a method 900 for computing a combined bounding box according to aspects of the present disclosure. Referring to FIG. 9, at operation 905, the system determines a first bounding box for the entity in the first frame. In some cases, the operations of this step refer to, or may be performed by, a machine learning model as described with reference to FIGS. 4 and 12. In an example, the machine learning model determines the first bounding box as described with reference to FIG. 4.

At operation 910, the system determines a second bounding box for the entity in the second frame. In some cases, the operations of this step refer to, or may be performed by, a machine learning model as described with reference to FIGS. 4 and 12. In an example, the machine learning model determines the second bounding box as described with reference to FIG. 4.

At operation 915, the system combines the first bounding box and the second bounding box to obtain the combined bounding box. In some cases, the operations of this step refer to, or may be performed by, a bounding box component as described with reference to FIGS. 4 and 12. In an example, the bounding box component obtains the combined bounding box as described with reference to FIG. 4.

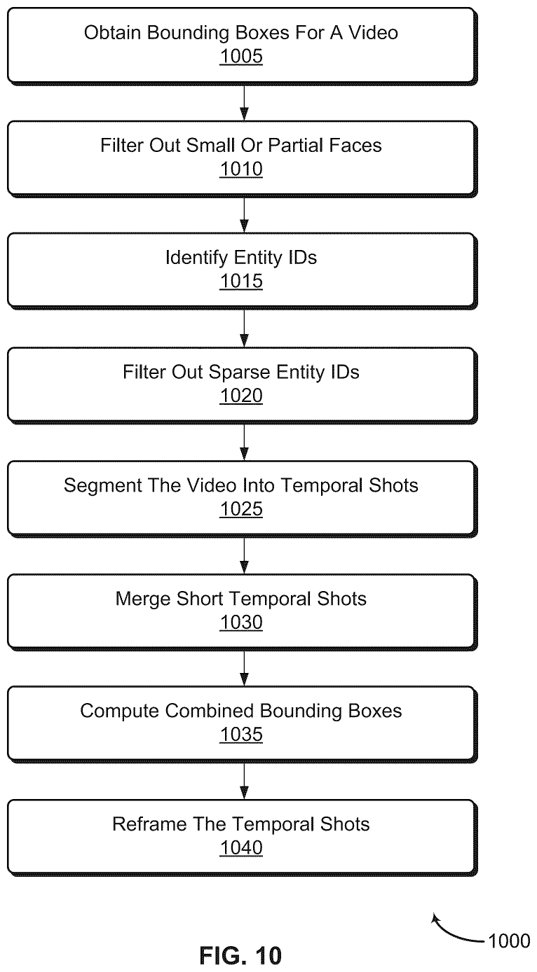

FIG. 10 shows an example of an algorithm 1000 for producing a modified video according to aspects of the present disclosure. According to some aspects, FIG. 10 illustrates an algorithm used by the media processing system 400 described with reference to FIG. 4 to produce a modified video. In an example, the media processing system obtains bounding boxes for a video (step 1005), and filters out bounding boxes corresponding to small or partial faces (step 1010). The media processing system then identifies entity IDs for one or more entities that are depicted in the video (step 1015), and filters out sparse entity IDs (step 1020).

The media processing system then segments the video into temporal shots based on the remaining entity IDs (step 1025) and merges short temporal shots into adjacent temporal shots (step 1030). The media processing system computes one or more combined bounding boxes for one or more entities, respectively, depicted in the temporal shots (step 1035). Finally, the media processing system reframes the temporal shots according to a target aspect ratio and the one or more combined bounding boxes to produce the modified video (step 1040).

Accordingly, a method for media processing is described. One or more aspects of the method include obtaining a video including a first frame depicting an entity and a second frame depicting the entity, wherein the video has a first aspect ratio; computing a combined bounding box for the entity based on the first frame and the second frame; and producing a modified video based on the combined bounding box, wherein the modified video has a second aspect ratio different from the first aspect ratio.

Some examples of the method further include determining a first bounding box for the entity in the first frame. Some examples further include determining a second bounding box for the entity in the second frame. Some examples further include combining the first bounding box and the second bounding box to obtain the combined bounding box. Some examples of the method further include identifying a first skeleton of the entity in the first frame and a second skeleton of the entity in the second frame, wherein the first bounding box is based on the first skeleton and the second bounding box is based on the second skeleton.

Some examples of the method further include computing an overlap between the first bounding box and the second bounding box. Some examples further include determining that the first bounding box and the second bounding box correspond to the entity based on the overlap.

Some examples of the method further include dividing the video into a plurality of temporal shots, wherein the first frame and the second frame are selected from a same temporal shot of the plurality of temporal shots. Some examples of the method further include obtaining a transcript of the video, wherein the plurality of temporal shots is based on the transcript.

Some examples of the method further include determining a center point based on the combined bounding box. Some examples further include reframing the video based on the center point to obtain the modified video. Some examples of the method further include filling in a gap area based on the reframing to obtain the modified video.

Some examples of the method further include determining that a corner of the combined bounding box is disposed in a corner of the video. Some examples further include identifying a ratio of a length of a side of the combined bounding box to a length of a side of the video. Some examples further include reframing the video based on the determination and the identification to obtain the modified video.

Some examples of the method further include dividing the video into a plurality of spatial blocks corresponding to a plurality of entities based on the combined bounding box. Some examples further include rearranging the plurality of spatial blocks to obtain the modified video.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Media Processing Apparatus

FIG. 11 shows an example of a computing device 1100 according to aspects of the present disclosure. Computing device 1100 is an example of, or includes aspects of, the media processing apparatus described with reference to FIGS. 1, 4, and 12. In one aspect, computing device 1100 includes processor(s) 1105, memory subsystem 1110, communication interface 1115, I/O interface 1120, user interface component(s) 1125, and channel 1130. In some embodiments, computing device 1100 includes one or more processors 1105 that can execute instructions stored in memory subsystem 1110.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 920 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of a media processing apparatus 1200 according to aspects of the present disclosure. Media processing apparatus 1200 is an example of, or includes aspects of, the corresponding element described with reference to FIGS. 1, 3, and 11. In some embodiments, media processing apparatus 1200 includes processor unit 1205, memory unit 1210, machine learning model 1215, bounding box component 1220, video reframing component 1225, and I/O module 1230.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors 1105 described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, media processing apparatus 1200 uses one or more processors of processor unit 1205 to execute instructions stored in memory unit 1210 to perform functions described herein. For example, the media processing apparatus 1200 may perform operations comprising obtaining a video including a first frame depicting an entity and a second frame depicting the entity, wherein the video has a first aspect ratio; computing a combined bounding box for the entity based on the first frame and the second frame; and producing a modified video based on the combined bounding box, wherein the modified video has a second aspect ratio different from the first aspect ratio.

The memory unit 1210 may include a machine learning model 1215 trained to determine a first bounding box for an entity in a first frame and to determine a second bounding box for the entity in a second frame. For example, in some embodiments, machine learning model 1215 is trained to identify a first skeleton of the entity in the first frame and a second skeleton of the entity in the second frame, where the first bounding box is based on the first skeleton and the second bounding box is based on the second skeleton. Machine learning model 1215 is an example of, or includes aspects of, the corresponding element described with reference to FIG. 4.

In some embodiments, the machine learning model 1215 is an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the machine learning model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

A training component may train the machine learning model 1215. For example, parameters of the machine learning model can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model 1215 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1215 can be used to make predictions on new, unseen data (i.e., during inference).

According to some aspects, bounding box component 1220 comprises processor-executable instructions stored in memory unit 1210, one or more hardware circuits, firmware, or a combination thereof. According to some aspects, bounding box component 1220 computes a combined bounding box for the entity based on the first frame and the second frame. In some examples, bounding box component 1220 combines the first bounding box and the second bounding box to obtain the combined bounding box.

In some examples, bounding box component 1220 computes an overlap between the first bounding box and the second bounding box. In some examples, bounding box component 1220 determines that the first bounding box and the second bounding box correspond to the entity based on the overlap. According to some aspects, bounding box component 1220 divides the video into a set of temporal shots, where the first frame and the second frame are selected from a same temporal shot of the set of temporal shots. In some examples, bounding box component 1220 obtains a transcript of the video, where the set of temporal shots are based on the transcript. Bounding box component 1220 is an example of, or includes aspects of, the corresponding element described with reference to FIG. 4.

According to some aspects, video reframing component 1225 comprises processor-executable instructions stored in memory unit 1210, one or more hardware circuits, firmware, or a combination thereof.

According to some aspects, video reframing component 1225 produces a modified video based on the combined bounding box, where the modified video has a second aspect ratio different from the first aspect ratio. In some examples, video reframing component 1225 determines a center point based on the combined bounding box. In some examples, video reframing component 1225 reframes the video based on the center point to obtain the modified video.

In some examples, video reframing component 1225 fills in a gap area based on the reframing to obtain the modified video. In some examples, video reframing component 1225 determines that a corner of the combined bounding box is disposed in a corner of the video. In some examples, video reframing component 1225 identifies a ratio of a length of a side of the combined bounding box to a length of a side of the video. In some examples, video reframing component 1225 reframes the video based on the determination and the identification to obtain the modified video.

In some examples, video reframing component 1225 divides the video into a set of spatial blocks corresponding to a set of entities based on the combined bounding box. In some examples, video reframing component 1225 rearranges the set of spatial blocks to obtain the modified video. Video reframing component 1225 is an example of, or includes aspects of, the corresponding element described with reference to FIG. 4.

I/O module 1230 receives inputs from and transmits outputs of the media processing apparatus 1200 to other devices or users. For example, I/O module 1230 receives inputs for the machine learning model 1215, the bounding box component 1220, and the video reframing component 1225, and transmits outputs of the machine learning model 1215, the bounding box component 1220, and the video reframing component 1225. According to some aspects, I/O module 1230 is an example of the I/O interface 1120 described with reference to FIG. 11.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for media processing, comprising:
obtaining a video including a first frame depicting an entity and a second frame depicting the entity, wherein the video has a first aspect ratio;
computing a combined bounding box for the entity based on the first frame and the second frame; and
producing a modified video based on the combined bounding box, wherein the modified video has a second aspect ratio different from the first aspect ratio.

2. The method of claim 1, wherein computing the combined bounding box comprises:
determining a first bounding box for the entity in the first frame;
determining a second bounding box for the entity in the second frame; and
combining the first bounding box and the second bounding box to obtain the combined bounding box.

3. The method of claim 2, further comprising:
identifying a first skeleton of the entity in the first frame and a second skeleton of the entity in the second frame, wherein the first bounding box is based on the first skeleton and the second bounding box is based on the second skeleton.

4. The method of claim 2, further comprising:
computing an overlap between the first bounding box and the second bounding box; and
determining that the first bounding box and the second bounding box correspond to the entity based on the overlap.

5. The method of claim 1, further comprising:
dividing the video into a plurality of temporal shots, wherein the first frame and the second frame are selected from a same temporal shot of the plurality of temporal shots.

6. The method of claim 5, further comprising:
obtaining a transcript of the video, wherein the plurality of temporal shots is based on the transcript.

7. The method of claim 1, wherein producing the modified video comprises:
determining a center point based on the combined bounding box; and
reframing the video based on the center point to obtain the modified video.

8. The method of claim 7, further comprising:
filling in a gap area based on the reframing to obtain the modified video.

9. The method of claim 1, wherein producing the modified video comprises:
determining that a corner of the combined bounding box is disposed in a corner of the video;
identifying a ratio of a length of a side of the combined bounding box to a length of a side of the video; and
reframing the video based on the determination and the identification to obtain the modified video.

10. The method of claim 1, wherein producing the modified video comprises:
dividing the video into a plurality of spatial blocks corresponding to a plurality of entities based on the combined bounding box; and
rearranging the plurality of spatial blocks to obtain the modified video.

11. A non-transitory computer readable medium storing code for media processing, the code comprising instructions that, when executed by at least one processor, cause the at least one processor to perform operations comprising:
obtaining a video including a first frame depicting an entity and a second frame depicting the entity, wherein the video has a first aspect ratio;
computing a combined bounding box for the entity based on the first frame and the second frame; and
producing a modified video based on the combined bounding box, wherein the modified video has a second aspect ratio different from the first aspect ratio.

12. The non-transitory computer readable medium of claim 11, wherein computing the combined bounding box comprises:
determining a first bounding box for the entity in the first frame;
determining a second bounding box for the entity in the second frame; and
combining the first bounding box and the second bounding box to obtain the combined bounding box.

13. The non-transitory computer readable medium of claim 12, the code further comprising instructions that, when executed by the at least one processor, cause the at least one processor to perform operations comprising:
identifying a first skeleton of the entity in the first frame and a second skeleton of the entity in the second frame, wherein the first bounding box is based on the first skeleton and the second bounding box is based on the second skeleton.

14. The non-transitory computer readable medium of claim 12, the code further comprising instructions that, when executed by the at least one processor, cause the at least one processor to perform operations comprising:
computing an overlap between the first bounding box and the second bounding box; and
determining that the first bounding box and the second bounding box correspond to the entity based on the overlap.

15. The non-transitory computer readable medium of claim 11, wherein producing the modified video comprises:
determining a center point based on the combined bounding box; and
reframing the video based on the center point to obtain the modified video.

16. The non-transitory computer readable medium of claim 15, the code further comprising instructions that, when executed by the at least one processor, cause the at least one processor to perform operations comprising:
filling in a gap area based on the reframing to obtain the modified video.

17. The non-transitory computer readable medium of claim 11, wherein producing the modified video comprises:
determining that a corner of the combined bounding box is disposed in a corner of the video;
identifying a ratio of a length of a side of the combined bounding box to a length of a side of the video; and
reframing the video based on the determination and the identification to obtain the modified video.

18. The non-transitory computer readable medium of claim 11, wherein producing the modified video comprises:
dividing the video into a plurality of spatial blocks corresponding to a plurality of entities based on the combined bounding box; and
rearranging the plurality of spatial blocks to obtain the modified video.

19. A system comprising:
a memory component; and
a processing device coupled to the memory component, the processing device configured to perform operations comprising:
obtaining a video including a first frame depicting an entity and a second frame depicting the entity, wherein the video has a first aspect ratio;
computing a combined bounding box for the entity based on the first frame and the second frame; and
producing a modified video based on the combined bounding box, wherein the modified video has a second aspect ratio different from the first aspect ratio.

20. The system of claim 19, the processing device being further configured to:
determining a first bounding box for the entity in the first frame;
determining a second bounding box for the entity in the second frame; and
combining the first bounding box and the second bounding box to obtain the combined bounding box.
